(19) United States
(12) Patent Application Publication
(10) Pub. No.: US 2014/0198506 A1
(43) Pub. Date: Jul. 17, 2014

(54) LIGHTING DEVICE

(71) Applicants: Cheng-Yen Chen, Tainan City (TW); Yi-Hao Huang, Tainan City (TW); Kuan-Wen Chen, Tainan City (TW)

(72) Inventors: Cheng-Yen Chen, Tainan City (TW); Yi-Hao Huang, Tainan City (TW); Kuan-Wen Chen, Tainan City (TW)

(73) Assignee: GENESIS PHOTONICS INC., Tainan City (TW)

(21) Appl. No.: 14/096,017

(22) Filed: Dec. 4, 2013

Related U.S. Application Data
(60) Provisional application No. 61/752,405, filed on Jan. 14, 2013.

(30) Foreign Application Priority Data
Sep. 25, 2013 (TW) 102134569

(51) Int. Cl. F21V 13/02; F21V 1/00; F21V 9/08

(52) U.S. Cl. CPC F21V 13/02; F21V 9/08; F21V 1/00
USPC 362/293

(57) ABSTRACT

A lighting device includes a light base, a light shade, a padding element, at least one light emitting element and a wavelength converting shell. The light shade is disposed on the light base and cooperating with the light base to define an accommodating space. The padding element is disposed on the light base and located in the accommodating space. The light emitting element is disposed on the padding element and emits a light beam. The wavelength converting shell is disposed on the padding element and covers the light emitting element. The light beam is emitted out from the wavelength converting shall by a first refraction, formed a luminous virtual image between a first top end of the light shade and a second top end of the wavelength converting shell by reflecting, and emitted out the light shade by a second refraction.

### CROSS-REFERENCE TO RELATED APPLICATION

This application claims the priority benefits of U.S. provisional application Ser. No. 61/752,405, filed on Jan. 14, 2013 and Taiwan application serial no. 102134569, filed on Sep. 25, 2013. The entirety of each of the above-mentioned patent applications is hereby incorporated by reference herein and made a part of this specification.

### BACKGROUND OF THE INVENTION

1. Field of the Invention

The invention relates to a lighting device, and particularly to a candlelight-like lighting device.

2. Description of Related Art

Candles are the useful lighting device, which are not only for illuminating, but sometimes also for producing an atmospheric situation. However, in recent years, due to the rising of environmental awareness, the use of the traditional candles has been questioned. Accordingly, the simulated candles which can be repeatedly used, do not create pollution, and can achieve the effect of candlelight have gradually being taken seriously.

### SUMMARY OF THE INVENTION

The invention is directed to a lighting device, wherein a light beam emitted out from a light emitting element thereof forms a luminous virtual image between a light shade and a wavelength converting shell due to optical effects, which can generate an image, similar to candlelight.

The lighting device of the invention includes a light base, a light shade, a padding element, at least one light emitting element, and a wavelength converting shell. The light shade is disposed on the light base and cooperating with the light base to define an accommodating space. The padding element is disposed on the light base and located in the accommodating space. The light emitting element is disposed on the padding element and emits a light beam. The wavelength converting shell is disposed on the padding element and covers the light emitting element. The light beam is emitted out from the wavelength converting shell by a first refraction, formed a luminous virtual image between a first top end of the light shade and a second top end of the wavelength converting shell by reflecting, and then emitted out the light shade by a second refraction.

In an embodiment of the invention, the padding element has a reflective surface.

In an embodiment of the invention, the padding element has a carrying surface and a bottom surface opposite to the carrying surface. The light emitting element is disposed on the carrying surface, the bottom surface contacts the light base, and a width of the padding element from the carrying surface towards the bottom surface gradually decreases first and then gradually increases.

In an embodiment of the invention, the lighting device further includes two wires. The two wires are electrically connected to the light emitting element and extend from the carrying surface of the padding element to the light base.

In an embodiment of the invention, the padding element is formed by a combination of the plurality of pillars.

In an embodiment of the invention, the light shade has a horizontal axis passing through the second top end of the wavelength converting shell. The horizontal axis divides the light shade into an upper light shade portion located from the first top end to the horizontal axis and a lower light shade portion located from the horizontal axis to the light base.

In an embodiment of the invention, a radius of curvature of the upper light shade portion is similar to a radius of curvature of the wavelength converting shell.

In an embodiment of the invention, the upper light shade portion conforms to the wavelength converting shell.

In an embodiment of the invention, a thickness of the upper light shade portion is greater than a thickness of the lower light shade portion.

In an embodiment of the invention, an interior of the upper light shade portion has a rough surface, and a central line average roughness of the rough surface is between 0.05 μm to 10 μm.

In an embodiment of the invention, the light shade has a symmetrical axial plane, and the symmetrical axial plane divides the light shade into two curved surfaces. A distance between the wavelength converting shell and each of the curved surfaces is less than an effective focal length of each of the curved surfaces.

In an embodiment of the invention, a height of the padding element is 0.1 to 0.6 times a height of the light shade.

In an embodiment of the invention, the at least one light emitting element includes at least one light emitting diode chip.

In an embodiment of the invention, the light shade has a vertical axis passing through the first top end and the second top end, and the luminous virtual image extends from the second top end of the wavelength converting shell to the first top end of the light shade along the vertical axis.

According to the above, the light beam emitted out from the light emitting element of the invention forms the luminous virtual image between the light shade and the wavelength converting shell due to the optical effects (reflection and two-time refractions). Therefore, the lighting device can also provide the functions of illumination and simulating the candlelight-like to be more realistic with the luminous virtual image to make the light beam appear to have an extended effect.

In order to make the aforementioned and other features and advantages of the invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic diagram of a lighting device according to an embodiment of the invention.

FIG. 2 illustrates a schematic diagram of a lighting device according to another embodiment of the invention.

FIG. 3 illustrates a schematic diagram of a lighting device according to another embodiment of the invention.

FIG. 4 illustrates a schematic diagram of a lighting device according to another embodiment of the invention.

FIG. 5 illustrates a schematic diagram of a lighting device according to another embodiment of the invention.

FIG. 6 illustrates a schematic diagram of a lighting device according to another embodiment of the invention.

### DESCRIPTION OF EMBODIMENTS

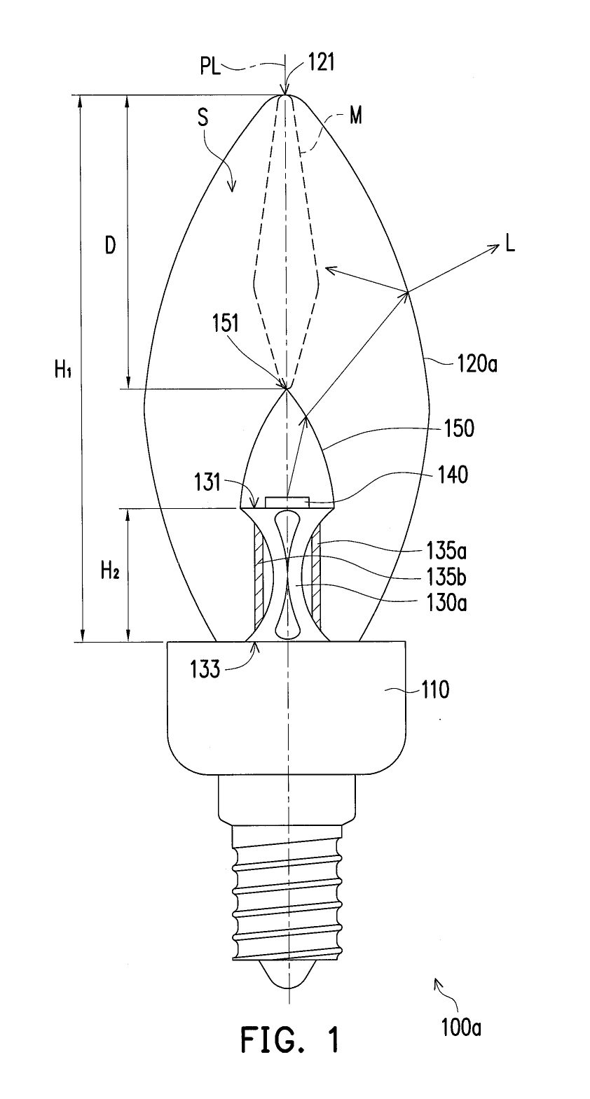

FIG. 1 illustrates a schematic diagram of a lighting device according to an embodiment of the invention. Please refer to FIG. 1, in the present embodiment, a lighting device 100a includes a light base 110, a light shade 120a, a padding element 130a, at least one light emitting element 140 (which is schematically illustrated only one in FIG. 1), and a wavelength converting shell 150. The light shade 120a is disposed on the light base 110 and cooperating with the light base 110 to define an accommodating space S. The padding element 130a is disposed on the light base 110 and located in the accommodating space S. The light emitting element 140 is disposed on the padding element 130a and emits a light beam L. The wavelength converting shell 150 is disposed on the padding element 130a and covers the light emitting element 140. The light beam L is emitted out from the wavelength converting shell 150 by a first refraction, formed a luminous virtual image M between a first top end 121 of the light shade 120a and a second top end 151 of the wavelength converting shell 150 by reflecting, and then emitted out the light shade 120a by a second refraction.

More specifically, the padding element 130a has a carrying surface 131 and a bottom surface 133 opposite to the carrying surface 131. The light emitting element 140 is disposed on the carrying surface 131 of the padding element 130a, and the bottom surface 133 of the padding element 130a directly contacts the light base 110. The light emitting element 140 is, for example, a light emitting diode (LED) chip, but is not limited thereto. Note that the padding element 130a of the present embodiment is embodied as a one-piece structure, and a width of the padding element 130a from the carrying surface 131 towards the bottom surface 133 gradually decrease first and then gradually increases. That is, the padding element 130a is shown as an exterior contour with both wide upper and lower ends and a narrow middle, which may have a better visual effect. Herein, a surface area of the carrying surface 131 of the padding element 130a may be equal to a surface area of the bottom surface 133, but is not limited thereto. In particular, the padding element 130a of the present embodiment has a reflective surface, and the material thereof is such as metal. When the material of the padding element 130a of the present embodiment is metal, it may also have a function of heat dissipation, which effectively guides out the heat generated by the light emitting element 140. Furthermore, since the light emitting element 140 is disposed on the padding element 130a, the light beam L emitted out from the light emitting element 140 will not be disturbed by the light base 110 so as to achieve the effect of the full circumferential light.

Herein, a height H2 of the padding element 130a of the present embodiment is 0.1 to 0.6 times a height H1 of the light shade 120a. When the height H2 of the padding element 130a is less than 0.1 times the height H1 of the light shade 120a, the light emitting element 140 located on the padding element 130a is too low that the light is easily shaded by the light base 110, which makes the effect of the full circumferential light unable to be achieved; when the height H2 of the padding element 130a is greater than 0.6 times the height H1 of the light shade 120a, the light emitting element 140 is too close to the first top end 121 of the light shade 120a, which makes the optical effects such as the reflection and the two-time refractions of the light difficult to be produced in the light shade 120a, and thus makes the luminous virtual image M difficult to be formed. Preferably, the height H2 of the padding element 130a 0.2 to 0.4 times the height H1 of the light shade 120a. In addition, the light shade 120a of the present embodiment has a vertical axis PL passing through the first top end 121 and the second top end 151, wherein the luminous virtual image M extends from the second top end 151 of the wavelength converting shell 150 to the first top end 121 of the light shade 120a along the vertical axis PL. Since the luminous virtual image M is not an entity, different visual experiences change with variation of viewing angles. Thereby, the blinking and blurred visual effects of the candlelight can be simulated in the case without affecting the lighting brightness and the lighting effects of the lighting device 100a.

Furthermore, the wavelength converting shell 150 of the present embodiment is disposed on the carrying surface 131 of the padding element 130a and covers the light emitting element 140 completely, wherein the light beam L emitted out from the light emitting element 140 will pass through the wavelength converting shell 150 first and then be emitted out through the first refraction. Accordingly, the light beam L with short wavelength and strong energy can be converted to radiation of longer wavelength (for example, converting blue light to yellow light), thereby reducing the harm from the light beam L to the human eye. Also, the lighting device 100a as a whole can have the same light color. Additionally, the lighting device 100a of the present embodiment further includes two wires 135a, 135b, wherein the wires 135a, 135b are electrically connected to the light emitting element 140 through the padding element 130a, and the wires 135a, 135b extend from the carrying surface 131 of the padding element 130a into the light base 110.

The light beam L emitted out from the light emitting element 140 of the present embodiment forms the luminous virtual image M between the light shade 120a and the wavelength converting shell 150 through the optical effects such as the reflection and the two-time refractions, wherein different visual experiences of the luminous virtual image M change with variation of the viewing angles. Accordingly, the blinking and blurred visual effects of the candlelight can be simulated in the case without affecting the lighting brightness and the lighting effects of the lighting device 100a. That is, with the luminous virtual image M, the light beam L can appear to have the extended effect so as to simulate the candlelight-like to be more realistic. Furthermore, in addition to the effect of heat dissipation, the padding element 130a of the present embodiment can also make the light emitting element 140 located on the padding element 130a to be achieved the effect of the full circumferential light.

Note that following embodiments follow the reference numbers and parts of the content of the embodiments above, wherein the same reference numbers are used to refer to the same or like elements and the descriptions of the contents of the same techniques are omitted. As for the descriptions of the omitted part, the embodiments above can be referred to, and are not iterated again herein.

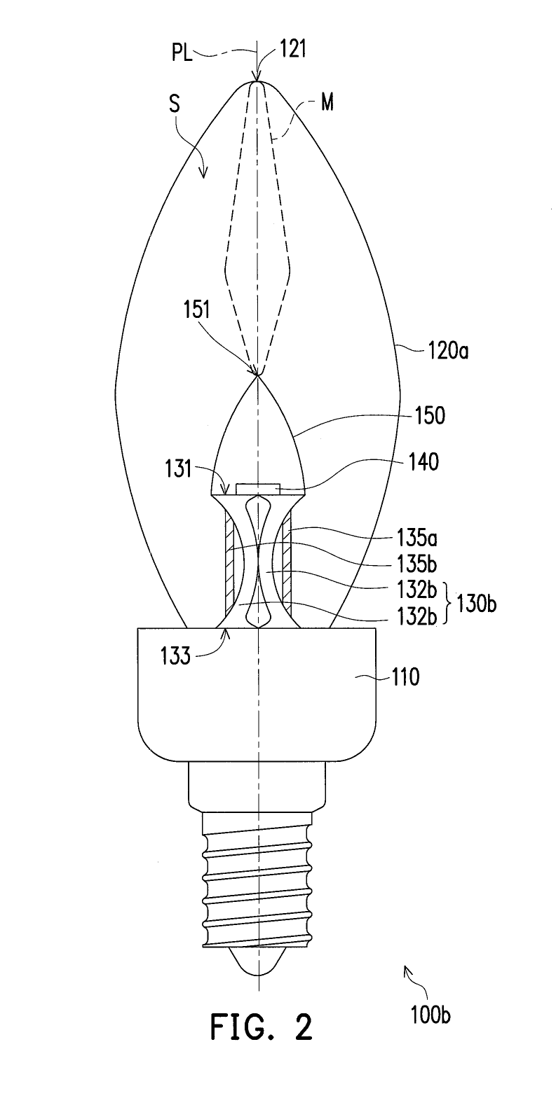

FIG. 2 illustrates a schematic diagram of a lighting device according to another embodiment of the invention. Please refer to FIG. 2, the lighting device 100b of the present embodiment is similar to the lighting device 100a in FIG. 1. The main difference between the lighting device 100b and the lighting device 100a is that the padding element 130b of the lighting device 100b of the present embodiment is not the one-piece structure but is a structure of a combination of a plurality of pillars 132b.

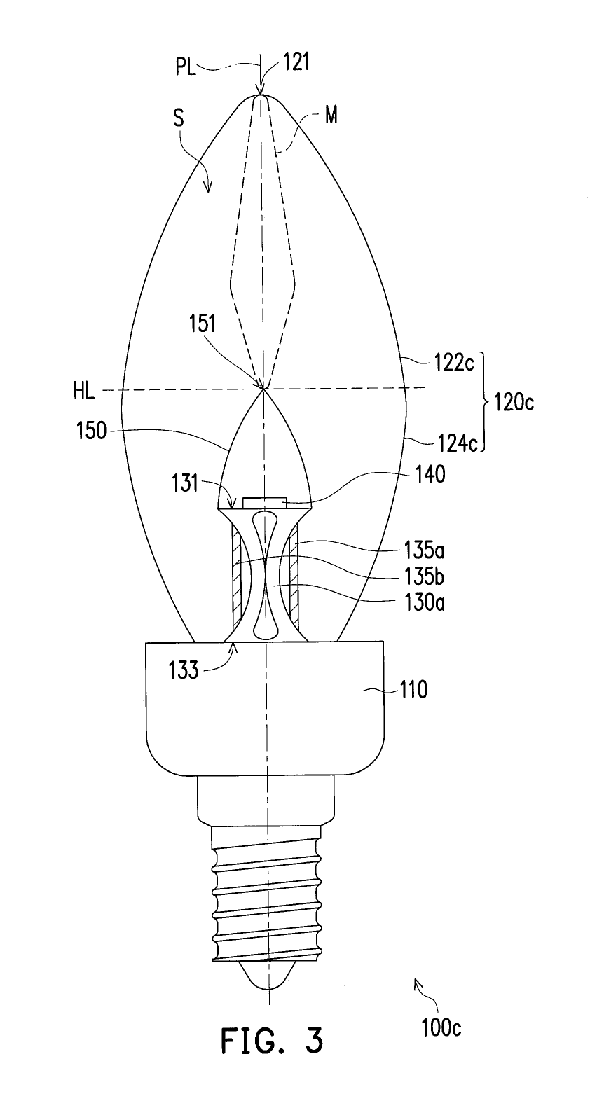

FIG. 3 illustrates a schematic diagram of a lighting device according to another embodiment of the invention. Please refer to FIG. 3, the lighting device 100c of the present embodiment is similar to the lighting device 100a in FIG. 1. The main difference between the lighting device 100c and the lighting device 100a is that the light shade 120c of the lighting device 100c of the present embodiment has a horizontal axis HL passing through the second top end 151 of the wavelength converting shell 150. The horizontal axis HL divides the light shade 120c into an upper light shade portion 122c located from the first top end 121 to the horizontal axis HL and a lower light shade portion 124c located from the horizontal axis HL to the light base 110. In particular, based on the vertical axis PL, a radius of curvature of the upper light shade portion 122c is similar to a radius of curvature of the wavelength converting shell 150, and the upper light shade portion 122c and the wavelength converting shell 150 are showed to be symmetrical to each other. Furthermore, the upper light shade portion 122c conforms to the wavelength converting shell 150.

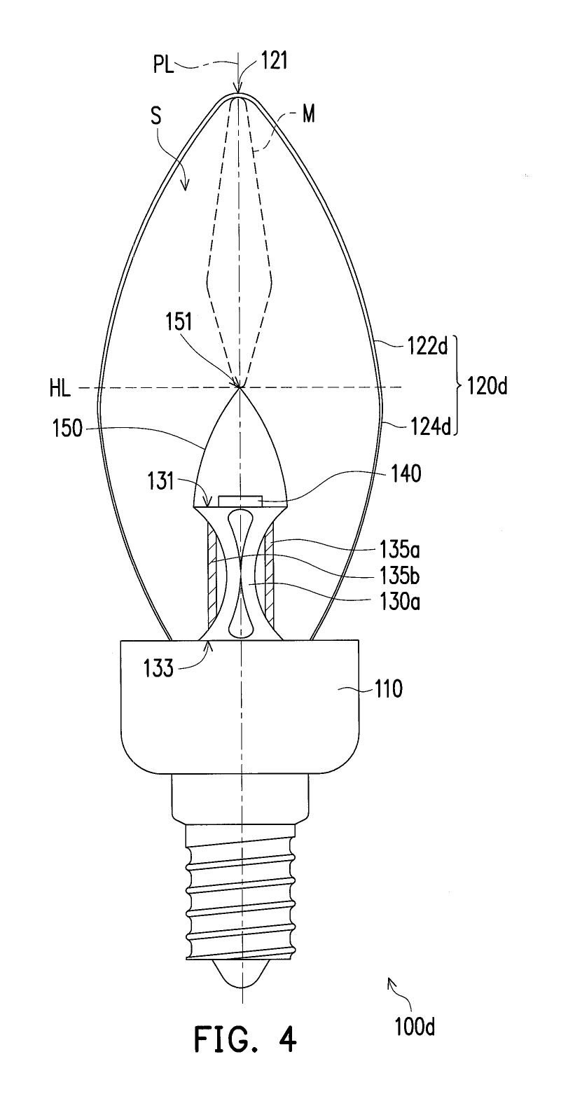

FIG. 4 illustrates a schematic diagram of a lighting device according to another embodiment of the invention. Please refer to FIG. 4, the lighting device 100d of the present embodiment is similar to the lighting device 100c in FIG. 3. The main difference between the lighting device 100d and the lighting device 100c is that a thickness of an upper light shade portion 122d of a light shade 120d of the present embodiment is greater than a thickness of a lower light shade portion 124d of the light shade 120d.

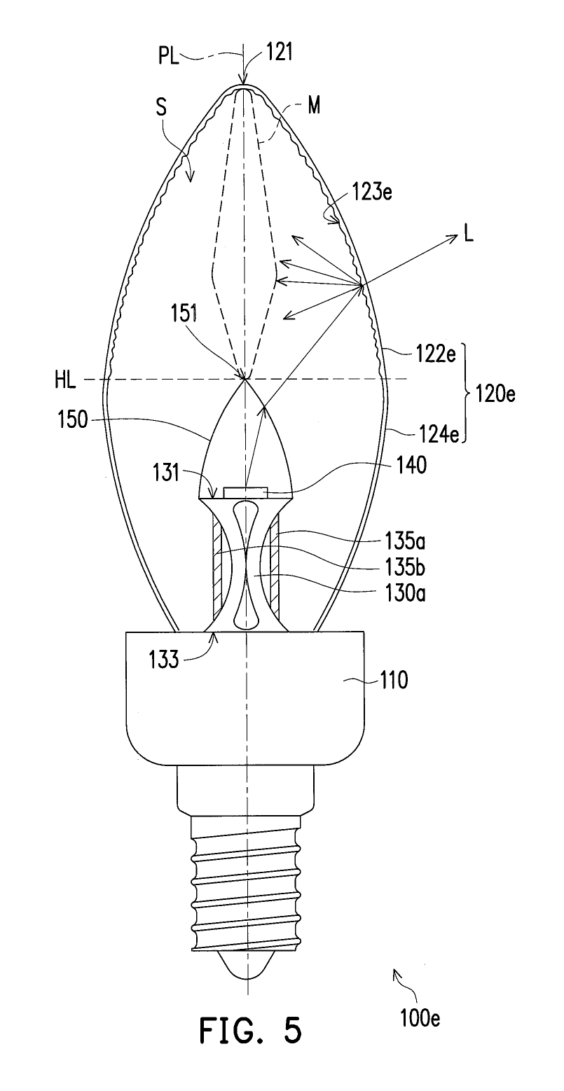

FIG. 5 illustrates a schematic diagram of a lighting device according to another embodiment of the invention. Please refer to FIG. 5, the lighting device 100e of the present embodiment is similar to the lighting device 100c in FIG. 3. The main difference between the lighting device 100e and the lighting device 100c is that a thickness of an upper light shade portion 122e of a light shade 120e of the present embodiment is substantially the same as a thickness of a lower light shade portion 124e of the light shade 120d. Moreover, an interior of the upper light shade portion 122e has a rough surface 123e, wherein a central line average roughness of the rough surface 123e is between 0.05 μm to 10 μm, which effectively enhances scattering effects of the light beam L.

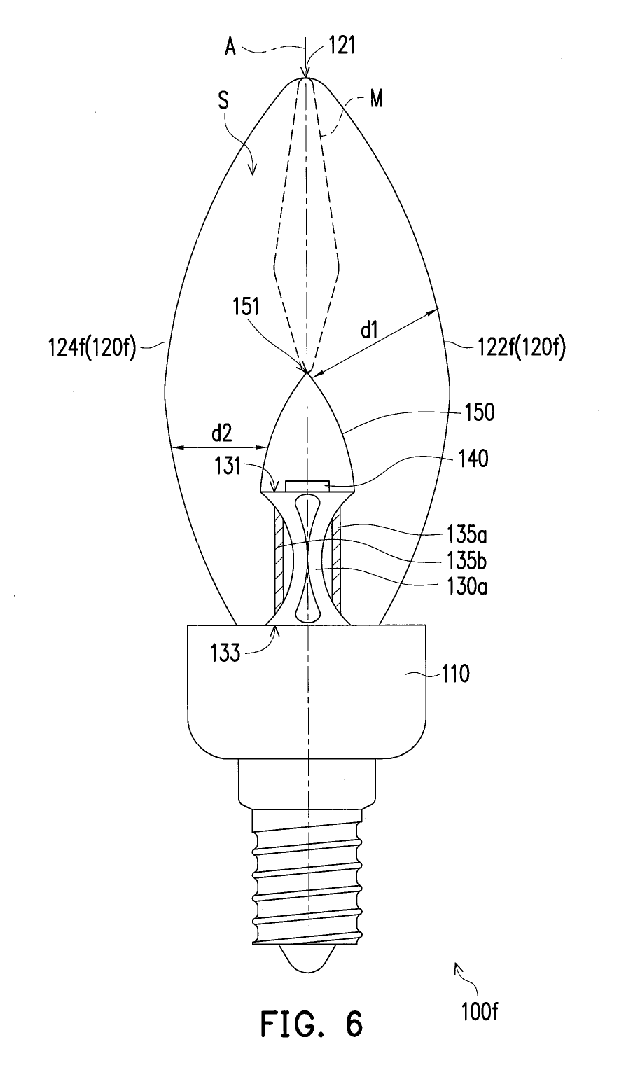

FIG. 6 illustrates a schematic diagram of a lighting device according to another embodiment of the invention. Please refer to FIG. 6, the lighting device 100f of the present embodiment is similar to the lighting device 100a in FIG. 1. The main difference between the lighting device 100f and the lighting device 100a is that a light shade 120f of the present embodiment has a symmetrical axial plane A, and the symmetrical axial plane A divides the light shade 120f into two curved surfaces 122f, 124f. A distance d1 (or d2) between the wavelength converting shell 150 and each of the curved surfaces 122f (or 1240 is less than an effective focal length of each of the curved surfaces 122f (or 1240.

According to the above, the light beam emitted out from the light emitting element of the present embodiment forms the luminous virtual image between the light shade and the wavelength converting shell through the optical effects such as the reflection and the two-time refractions, wherein different visual experiences of the luminous virtual image change with variation of the viewing angles. Accordingly, the blinking and blurred visual effects of the candlelight can be simulated in the case without affecting the lighting brightness and the lighting effects of the lighting device. Furthermore, in addition to the effect of heat dissipation, the padding element of the invention can also make the light emitting element located on the padding element to be achieved the effect of the full circumferential light.

It will be apparent to those skilled in the art that various modifications and variations can be made to the structure of the disclosed embodiments without departing from the scope or spirit of the invention. In view of the foregoing, it is intended that the disclosure cover modifications and variations of this specification provided they fall within the scope of the following claims and their equivalents.

What is claimed is:

1. A lighting device, comprising:
a light base;
a light shade, disposed on the light base and cooperating with the light base to define an accommodating space;
a padding element, disposed on the light base and located in the accommodating space;
at least one light emitting element, disposed on the padding element and emitting a light beam; and
a wavelength converting shell, disposed on the padding element and covering the light emitting element, wherein the light beam is emitted out from the wavelength converting shall by a first refraction, formed a luminous virtual image between a first top end of the light shade and a second top end of the wavelength converting shell by reflecting, and emitted out the light shade by a second refraction.

2. The lighting device as claimed in claim 1, wherein the padding element has a reflective surface.

3. The lighting device as claimed in claim 1, wherein the padding element has a carrying surface and a bottom surface opposite to the carrying surface, the light emitting element is disposed on the carrying surface, the bottom surface contacts the light base, and a width of the padding element from the carrying surface towards the bottom surface gradually decreases first and then gradually increases.

4. The lighting device as claimed in claim 3, further comprising:
two wires, electrically connected to the light emitting element and extending from the carrying surface of the padding element to the light base.

5. The lighting device as claimed in claim 1, wherein the padding element is formed by a combination of a plurality of pillars.

6. The lighting device as claimed in claim 1, wherein the light shade has a horizontal axis passing through the second top end of the wavelength converting shell, and the horizontal axis divides the light shade into an upper light shade portion located from the first top end to the horizontal axis and a lower light shade portion located from the horizontal axis to the light base.

7. The lighting device as claimed in claim 6, wherein a radius of curvature of the upper light shade portion is similar to a radius of curvature of the wavelength converting shell.

8. The lighting device as claimed in claim 6, wherein the upper light shade portion conforms to the wavelength converting shell.

9. The lighting device as claimed in claim 6, wherein a thickness of the upper light shade portion is greater than a thickness of the lower light shade portion.

10. The lighting device as claimed in claim 6, wherein an interior of the upper light shade portion has a rough surface, and a central line average roughness of the rough surface is between 0.05 μm to 10 μm.

11. The lighting device as claimed in claim 1, wherein the light shade has a symmetrical axial plane, the symmetrical axial plane divides the light shade into two curved surfaces, a distance between the wavelength converting shell and each of the curved surfaces is less than an effective focal length of each of the curved surfaces.

12. The lighting device as claimed in claim 1, wherein a height of the padding element is 0.1 to 0.6 times a height of the light shade.

13. The lighting device as claimed in claim 1, wherein the at least one light emitting element comprises at least one light emitting diode chip.

14. The lighting device as claimed in claim 1, wherein the light shade has a vertical axis passing through the first top end and the second top end, and the luminous virtual image extends from the second top end of the wavelength converting shell to the first top end of the light shade along the vertical axis.
